(19) United States
(12) Patent Application Publication
(10) Pub. No.: US 2024/0109625 A1
(43) Pub. Date: Apr. 4, 2024

(54) FLOATING PRODUCTION STORAGE AND OFFLOADING VESSEL FOR PRODUCTION OF HYDROGEN AND AMMONIA

(71) Applicant: Puneet Sharma, Houston, TX (US)

(72) Inventor: Puneet Sharma, Houston, TX (US)

(21) Appl. No.: 18/475,777

(22) Filed: Sep. 27, 2023

Related U.S. Application Data
(60) Provisional application No. 63/411,456, filed on Sep. 29, 2022.

(51) Int. Cl. B63B 35/44; B63B 3/56; B63B 11/02; B63B 17/00; C01C 1/00

(52) U.S. Cl. CPC B63B 35/44; B63B 3/56; B63B 11/02; B63B 17/0027; C01C 1/003; B63B 2035/4486

(57) ABSTRACT

A floating vessel for use as a hydrogen and/or ammonia floating production storage and offloading vessel comprising an inner hull wall; at least two bulkheads, wherein the at least two bulkheads are disposed within the inner hull wall, forming at least three separate storage spaces; a series of cross-members, wherein the series of cross members are disposed between the at least two bulkheads to provide support and stability to the at least two bulkheads; and a deck, wherein the deck is supported by and disposed upon the at least two bulkheads; and wherein the at least three separate storage spaces are configured to contain gasses and/or liquids.

### CROSS-REFERENCE TO RELATED APPLICATION

This application claims priority to U.S. Provisional Patent Application No. 63/411,456, filed on Sep. 29, 2022, which is incorporated by reference herein.

### BACKGROUND

### Field

Embodiments provided herein relate to floating vessels. More particularly, embodiments provided herein relate to floating vessels for making and storing hydrogen and/or liquid ammonia.

### Description of the Related Art

According to the World Bank, the world currently flares roughly 3.25 trillion cubic feet of natural gas per year. The World Bank has solicited support to end this flaring by 2030, and a number of countries and companies have signed on to the initiative. While significant progress has been made, there is still much work to be done. Trillions of cubic feet of natural gas are also stranded in remote harsh environments worldwide where conventional solutions for recovery are currently not viable. While the oil and gas industry has embraced the use of Floating Production Storage and Offloading (hereinafter “FPSO”) solutions for processing oil, it has struggled to find commercially viable solutions for processing, storing and offloading the associated natural gas where the fields are remote from consumers, associated gas rates are relatively small, or the gas is heavily contaminated with undesirable components which are difficult to process offshore. In some cases, where the field operator does not have the capability to do so, the associated gas is flared. For example, in the Campeche field off the coast of Mexico, PEMEX flared 350 million standard cubic feet of gas per day in 2022 emitting 15,000 tonnes of unnecessary green-house gases. There also exist a number of small pockets of non-associated gas discoveries around the world which are not commercially viable to monetize on their own.

The Floating Liquefaction of Natural Gas (hereinafter “FLNG”) concept gained some support in recent years, but there remain technical limitations which prevent wide support. Further, the LNG process requires removal of undesirable components (such as water, carbon dioxide, sulfur) and hydrocarbons greater in carbon-chain length than Propane (C3) to extremely low level (i.e. parts per million), which is commercially difficult off-shore. Industry has also attempted to monetize the gas by converting it to a liquid such as diesel or methanol, but these solutions have not proven commercially viable at a large scale. Further, eventually when the gas is consumed, it produces Carbon Dioxide (CO2), a green-house gas. Recent directives published in the European Union, propose to tax gas end-user/consumers up to 75 Euro per ton of CO2 emitted in order to encourage carbon-capture and permanent sequestration, which is incredibly difficult to do as gas is typically consumed in the presence of air, which is 79% Nitrogen. Thus, after combustion, the effluent gas is mostly Nitrogen (N2) making the separation and sequestration of the produced CO2 challenging and expensive.

In recent years, hydrogen and ammonia have gained support as carbon-free fuels and many companies are attempting to develop renewable offshore hydrogen or ammonia solutions where seawater is separated into hydrogen and oxygen by electrolysis and the hydrogen is then either exported directly via pipeline or combined with nitrogen from surrounding air to produce ammonia, a concept sometimes called “Green Ammonia”. In this scenario, the power necessary to produce the hydrogen is brought to the facility via power-cables. Some of the solutions under consideration propose to use renewable energy such as solar, wave and wind energy, which by their very nature are intermittent. While the electrolysis process can adapt to the intermittency in power supply, the Ammonia process is less able to do so, thus it is generally prudent to include buffer volumes of the primary reactants (hydrogen, nitrogen, and fresh water) to ensure smooth continuous operation in the overall production facility design.

Another process, a concept sometimes called “Blue Ammonia”, where ammonia is produced from natural gas through conventional processes and the subsequently produced carbon dioxide is sequestered into a subsurface reservoir is also gaining popularity. In both the Green and Blue Ammonia processes, fresh water is required (either for electrolysis in Green Ammonia or steam reforming in Blue Ammonia).

However, each of the foregoing concepts require a specific and non-interchangeable production, storage, offloading, onloading, and transportation system.

There are numerous potential technical solutions in offshore oil and gas ranging from fixed platforms and jack-ups in shallow water to semi-submersibles and FPSOs in deep-water. While fixed platforms and jack-ups are the conventional shallow water solutions in developed offshore areas where the produced oil can be sent to an on-shore facility, the Floating Storage and Offloading (hereinafter “FSO”) and FPSO have become the preferred solution for areas where an existing onshore terminal does not exist. In FPSO and FSO strategies, the oil is stored in the hull and exported to trading tankers directly either side-by-side or tandem. Due to various reasons, FPSOs require a significantly higher amount of sea-water ballast than trading tankers. Due to the nature of their designs, it fairly easy to apportion some of the storage tanks in a conventional crude carrier design for alternate services such as storage of the primary reactants or ballast.

Most common ocean-going vessels are not designed to support any major equipment on top of the deck, whereas FPSOs are designed specifically to perform narrowly tailored tasks. While there exist vessels (ships) which can readily be converted into FPSOs for oil and gas, these cannot be readily converted into an FPSO focused on ammonia. Ammonia cannot be stored in the same way as oil, requiring its own specialized tanks and reservoirs. There do exist very large gas carriers (VLGC) which can transport up to 80,000 cubic meters of liquefied Ammonia with these specialized tanks and reservoirs. The nature of their design is such that they cannot be readily converted to support equipment or modules mounted on the top deck. As such, existing ammonia storage capable vessels can have minimal equipment on the top deck and either none or a singular central supporting bulkhead. This lack of multiple interior bulkheads means that the primary structural support of the production facilities mounted on the deck must span the entire width of the vessel reducing proportionally the amount of weight (and hence capacity) which can be apportioned to the production equipment making the solution commercially infeasible. Additionally, unlike crude carriers, there is limited opportunity in gas carriers to apportion or convert some of the tanks to store the primary reactants or ballast. Vessels that are significantly longer render construction highly infeasible in both cost and available dry dock locations.

There is a need, therefore, for a hull design that can properly and safely store ammonia, intermediate buffer reactants (hydrogen, nitrogen and fresh water), and ballast while also support a full array of ammonia production and green-house gas sequestration facilities on its top deck and to export hydrogen and/or ammonia.

### SUMMARY

A floating vessel for use as an ammonia floating production storage and offloading vessel comprising an inner hull wall; at least two bulkheads, wherein the at least two bulkheads are disposed within the inner hull wall, forming at least three separate storage spaces; a series of cross-members, wherein the series of cross members are disposed between the at least two bulkheads to provide support and stability to the at least two bulkheads; and a deck, wherein the deck is supported by and disposed upon the at least two bulkheads; and wherein the at least three separate storage spaces are configured to contain pressurized or liquified gases and liquids The floating vessel can further include an optional fourth storage space extending from the bow to stern and port to starboard below and/or around the primary storage space used for ballast.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 depicts an isometric view of a FPSO vessel, according to one or more embodiments provided herein.

FIG. 2 depicts a partial cross section of an illustrative mid-ship of the FPSO vessel, according to one or more embodiments provided herein.

FIG. 3 depicts an illustrative top view of the hull 100 at the mid-ship of the vessel shown in FIG. 2, according to one or more embodiments provided herein.

FIG. 4 depicts an illustrative isomeric of the mid-ship depicted in FIGS. 2-3, according to one or more embodiments provided herein.

FIG. 5 depicts an illustrative plan view of the deck depicted in FIGS. 1, 2 and 4.

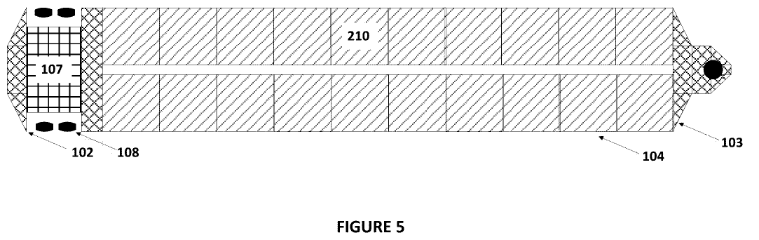

### DETAILED DESCRIPTION

A floating vessel is provided herein. The floating vessel can be used as a hydrogen and/or ammonia floating production storage and offloading and green-house gas sequestration vessel. In at least one embodiment, the floating vessel can be used to produce desirable quantities of hydrogen from natural gas or water. In at least one other embodiment, the floating vessel can also be used to produce desirable quantities of ammonia from natural gas, and store the produced ammonia in liquid state at temperatures less than −33° C. while at atmospheric pressure or at pressures greater than 17 Bar while at standard temperatures or any other suitable combination of temperature and pressure for storage and compress the produced carbon dioxide for sequestration. In one or more embodiments, the vessel can have an inner hull and at least two bulkheads that are arranged and located within the inner hull wall, defining at least three separate storage spaces therebetween. The vessel further can have at least two cross-members that are arranged and located between the at least two bulkheads to provide additional support and stability for a deck disposed on top of the hull. The deck can be supported by and disposed on the at least two bulkheads. The storage spaces can be used to contain one of more liquids, such as liquid ammonia, liquid petroleum gas (“LPG”), natural gas liquids (“NGL”), or water, and compressed or liquefied gasses such as hydrogen, nitrogen, oxygen, or carbon dioxide, or the like.

One or more support stools can be located on the deck, directly over, near, or about the two longitudinal bulkheads or the longitudinal double hull sides. The support stools can be used to support and affix any number of production facilities to the deck. The added cross-members are sized and designed to provide the requisite strength to allow any production facility to be located and operated on the top deck of the vessel. Such production facilities can be modular or skid mounted, and can be easily removed, relocated or installed anywhere along the top deck.

In one embodiment, the vessel may be a converted Ore Carrier that is normally used to transport Ore such as Coal or Iron Ore, and which would potentially be conducive for conversion into a hydrogen/ammonia FPSO. Ore Carriers such as the NewcastleMax, Very Large Ore Carrier (VLOC) and ValeMax range in size from roughly 50 to 65 meters in width and 300 to 360 meters in length. Vessel hulls provided herein can be between 45 meters, 50 meters, or 55 meters and 60 meters, 65 meters, or 68 meters in width and between 255 meters, 270 meters, or 285 meters and 350 meters, 360 meters, or 380 meters in length and can support facilities mounted above deck of any significant size and thus would be commercially feasible for a hydrogen/ammonia FPSO. In at least one embodiment, the vessel hull can be approximately 65 meters in width and approximately 360 meters in length.

A more detailed description of the preferred embodiments of the present invention will now be described below with reference to the figures provided. It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Furthermore, in the following discussion and in the claims, the terms “including” and “comprising” are used in an open-ended fashion, and thus should be interpreted to mean “including, but not limited to.”

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “a gas” include embodiments where one, two, or more gases are used, unless specified to the contrary or the context clearly indicates that only one gas is intended.

Unless otherwise indicated herein, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions, and examples, but the inventions are not limited to these embodiments, versions or examples, which are included to enable a person having ordinary skill in the art to make and use the inventions, when the information in this disclosure is combined with publicly available information and technology.

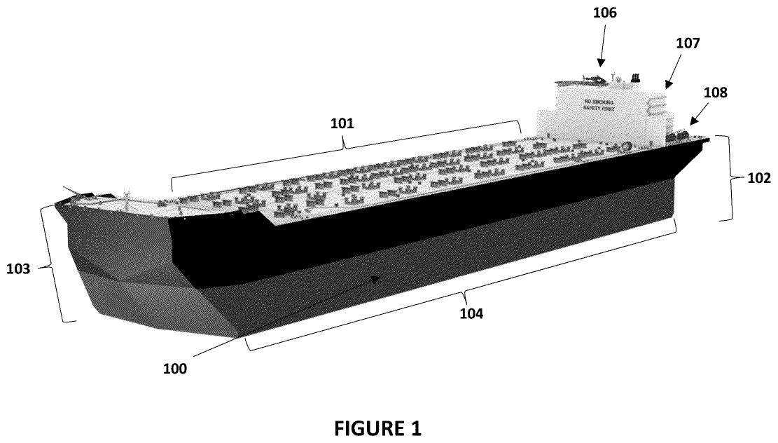

FIG. 1 depicts a schematic isometric view of a FPSO vessel, according to one or more embodiments. The FPSO has a single continuous deck 101 for supporting one or more processing modules. The deck 101 is arranged over a hull 100 that has a stern portion 102, a bow portion 103, and a storage portion 104 between the bow 103 and stern portions 102. The storage portion 104 can be housed and/or confined by the sides 205 and bottom 206 of the hull 100. The sides 205 and bottom 206 can be double walled, providing an empty void or space therein. As will be explained in more detail below, these voids and/or empty spaces can serve as ballasts for the vessel. The hull 100 can be of steel construction or any other suitable vessel construction material or any combinations thereof.

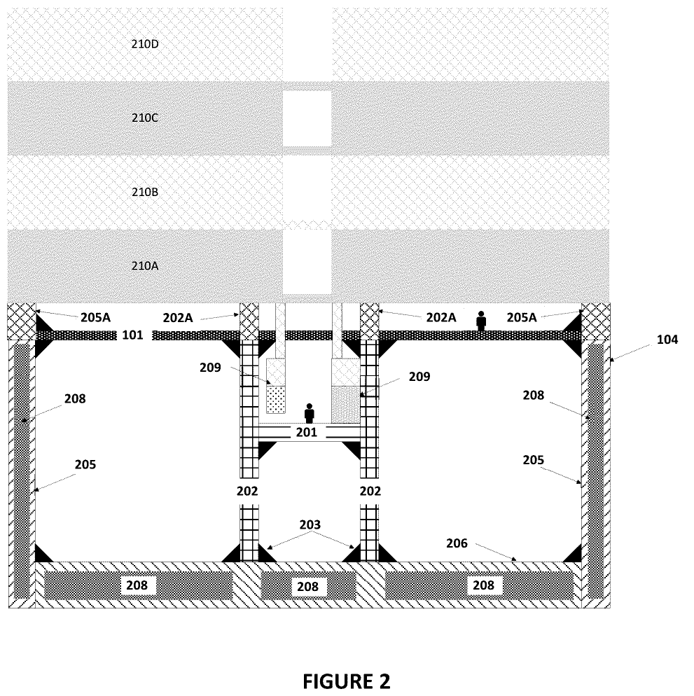

FIG. 2 depicts a partial cross section of the hull 100 at the mid-ship of the storage portion 104, according to one or more embodiments. Any one or more production modules 210 (four levels of production modules are shown 210A, 210B, 210C, 210D) can be located, disposed, mounted or otherwise supported on or above the upper deck 101. The storage portion 104 is located below the upper deck 101 and can include at least two longitudinal bulkheads 202 disposed therein. The longitudinal bulkheads 202 can extend in the longitudinal direction of the vessel (i.e. from the stern portion 102 to the bow portion 103). In one embodiment, the hull 100 can be approximately 360 meters in longitudinal length and the transverse distance between the longitudinal bulkheads 202 can range from 10 meters, 12.5 meters, or 15 meters to 17.5 meters, 20 meters, or 22.5 meters. The longitudinal bulkheads 202 can be located any desired distance from the side 205 of the hull 100. For example, the longitudinal bulkheads 202 can be located about 13 meters, 15 meters, or 17 meters, 20 meters, 25 meters, or 27.5 meters from the sides 205 of the hull 100. In one embodiment, the longitudinal bulkheads 202 can be between 10, 12 or 15 meters to 20, 25 or 28 meters from the sides 205 of the hull 100.

Any of the bulkheads 202, 207 can be affixed to the bottom 206 of the hull 100 using any one or more bulkhead supports or gussets 203. Any of the bulkheads 202, 207 also can be affixed to the top deck 101 using any one or more bulkhead supports 203. The bulkhead supports 203 can be any suitable shape that is configured to provide strength, reinforcement, and/or anti-buckling to the two longitudinal bulkheads 202. For example, the bulkhead supports 203 can be triangular, concave arc, convex arc, rectangular, or combinations thereof. When more than one bulkhead support 203 is used, the two or more bulkhead supports 203 can be spaced along the bulkheads 202, 207 on either or both sides of the bulkheads 202, 207. In one or more embodiments, the two or more bulkhead supports 203 can be spaced at a fixed interval on both sides of each of the bulkheads 202, 207. In one or more embodiments, the two or more bulkhead supports 203 can be located on both the top and the base of each of the bulkheads 202, 207. In one or more embodiments, the two or more bulkhead supports 203 can be arranged on each of the bulkheads 202, 207 at the same elevation or at different elevations. In at least one embodiment, the plurality of bulkhead supports 203 can be arranged on each of the bulkheads 202, 207 at the same elevations, using the same spacing intervals.

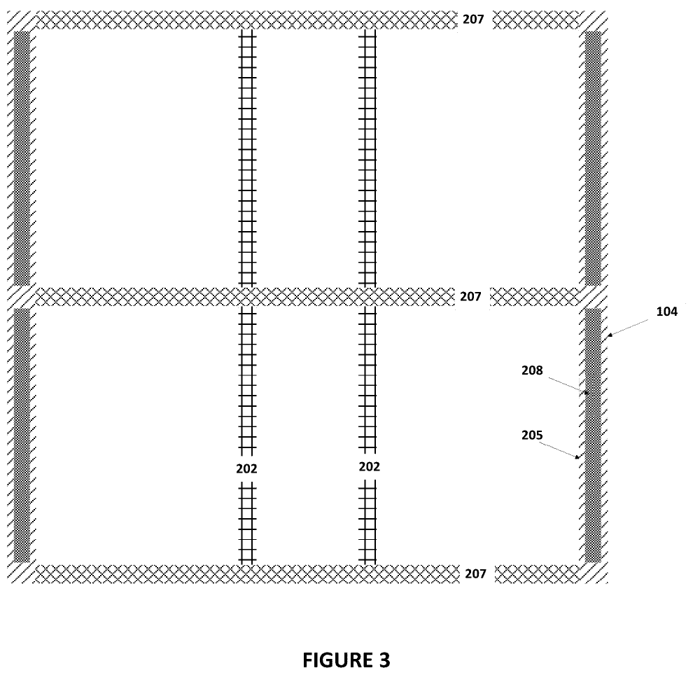

FIG. 3 depicts another illustrative partial longitudinal cross-section showing a top perspective view of storage portion 104 of the hull 100 at the mid-ship of the vessel shown in FIG. 2, according to one or more embodiments. The hull 100 can include two, three, four, five or more transverse bulkheads 207 in the storage portion 104. The transverse bulkheads 207 can be located 30, 35, 40, 45, and/or 50 meters apart. Referring to FIGS. 2 and 3, one or more cross-members 201 can be disposed between the two longitudinal bulkheads 202 to provide additional support and stability for the deck 101 disposed on top of the hull 100. The cross-members 201 can be any suitable shape able to provide strength, reinforcement, anti-buckling, and the like to the two longitudinal bulkheads 202, such as I-frame, T-frame, H-frame, triangular solid, rectangular solid, and the like, or combinations thereof. The cross-members 201 can be continuous and can run the entire length of the bulkheads 202. The cross-members 201 also can be arranged as ribs and run only a portion of the length of the bulkheads 202. Similarly, the cross-members 201 can run the entire height of the bulkheads 202 or only a portion of the height. In one or more embodiments, each cross-member 201 can be generally planar and horizontal and when two or more are used, the cross-members 201 can be spaced along the length of the longitudinal bulkheads 202.

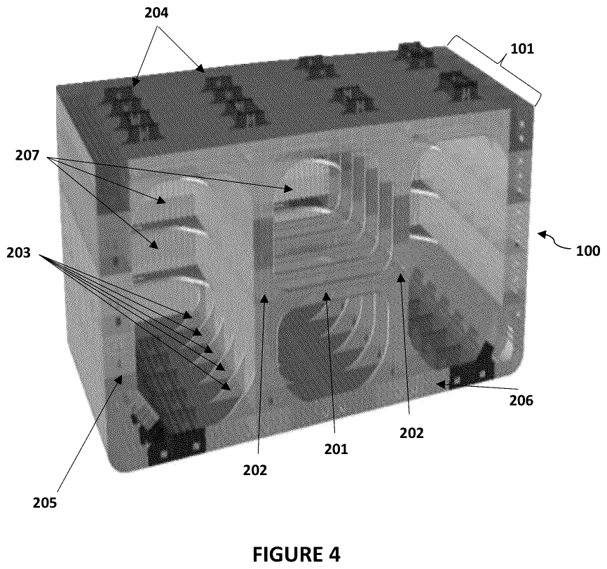

FIG. 4 depicts an illustrative isomeric of the mid-ship depicted in FIGS. 2-3, according to one or more embodiments. The one or more cross-members 201 can serve as cross bars or cross beams between any two bulkheads 202. The one or more cross-members 201 and the bulkheads 202 can be integral with one another to form a plate like structure and stacked together within the hull 100. In some embodiments, the cross-members 201 can be welded or otherwise affixed to the bulkheads 202. In some embodiments, one or more bulkhead supports 203 can be used to affix the cross-members 201 to the bulkheads 202 to provide additional support.

As mentioned above, any number of support stools 204 can be located on the deck 101. The support stools 204 can be used to support and affix any number of production facilities 210 to the single continuous deck 101. The support stools 204 can be located directly over, near, or about the transverse bulkheads 207, the longitudinal bulkheads 202 and/or the sides 205 of the hull 100. In an alternative embodiment, the bulkheads 202, 207 and/or sides 205 of the hull 100 can be extended above the deck 101 acting themselves 202A and 205A as support for the production facilities 210. Referring to FIG. 3, the upper or first ends 202A, 205A of the bulkheads 202, 207 and/or sides 205 of the hull 100 can extend above the deck 101, providing a support surface for connecting and/or supporting upper deck production facilities 210. Such production facilities 210 can be modular or skid mounted, and can be easily removed, relocated or installed anywhere along the top deck 101. In at least one embodiment, the storage portion 104 can be configured to store liquid ammonia, LPG, compressed hydrogen, compressed nitrogen, purified water, ballast, or natural gas liquids (hereinafter “NGL”), or the like. In one or more embodiments, the hull 100 can be insulated using any suitable type of insulation. In one or more embodiments, the cargo storage can be between 25,000 tons, 40,000 tons, or 55,000 tons and 90,000 tons or 120,000 tons or 180,000 tons. In one or more embodiments, the ballast can store up to 20,000 tons, 40,000 tons, or 70,000 tons.

In certain embodiments, the hull 100 can be configured to provide one, two, or three or more self-contained tanks confined within the bulkheads 202, 207, sides 205, bottom 206 and/or deck 101. The void spaces created by the bottom 206 and bulkheads 202, 207 can provide for storage of intermediate reactants (hydrogen, nitrogen and water). The void space created by the cross-members 201 and bulkheads 202 can provide space for a pipe and cable rack 209, which can extend all or a portion of the length of hull 100. The storage portion 104 can provide for one or more ballast storages 208 within the sides 205 and/or bottom 206 of the hull 100.

One or more self-contained storage tanks also can be located within the hull 100. The storage tanks can be permanently affixed within the hull 100 or can be removably affixed within the hull 100. The storage tanks can be constructed as a type B tank, type C tank, or a type C bi-lobe tank, for example.

Referring again to FIG. 1, the deck 101 can be configured to support a production facility weight between 9,000 metric tons, 10,000 metric tons, or 11,000 metric tons and 45,000 metric tons, 55,000 metric tons, or 65,000 metric tons. In one or more embodiments, the single continuous deck 101 can be configured with support stools 204 that support and affix production facilities to the single continuous deck 101. In at least one embodiment, the support stools 204 can support production facilities as skids, packages, towers, or modules of at least 10 metric tons, 100 metric tons, 1,000 metric tons, or 10,000 metric tons each. The support stools 204 can be configured according to the bulkhead 202, 207 locations, deck framing, deck layout, and production facility geometries. The support stools 204 can be used to removably affix production facilities to the deck 101 by any appropriate method. For example, illustrative production facilities 210 for producing hydrogen and/or ammonia on top of the vessel can include any one or more of the following equipment and/or units: reactors, compressors, separators, syngas reformers, electrical, power, air separation units, cranes, laydowns, E-house, power stations, and/or other utilities, piping, controllers, etc. Additional details of an ammonia production facility are disclosed and described in US Publications No. 2021/0002141, U.S. Pat. No. 10,597,301, and the like, which are all incorporated by reference herein.

The FPSO can also include living quarters 107 at the stern portion 102 of the FPSO. In one or more embodiments, the living quarters 107 can include housing between 20 personnel, 25 personnel, or 30 personnel and 220 personnel, 240 personnel, or 260 personnel. The living quarters can include any one or more offices, work-shops, spare parts storage, tele-communications (satellite, VHF, optic fiber or the like) galleys, and control rooms. In one embodiment, the living quarters is unmanned and the FPSO is monitored and/or controlled remotely using tele-communications or the like. Additionally, the living quarters 107 can include lifeboats 108 mounted to the sides of the living quarters 107. In at least one embodiment, the living quarters 107 can accommodate at least 140 personnel, 150 personnel, or 160 personnel and include a minimum of 4×50% or 2×100% of any suitable lifeboats 108 mounted to the sides of the living quarters 107 and a helideck 106 affixed to the top of the living quarters 107.

The FPSO can also include any suitable mooring system, such as internal turret, external turret, spread mooring, tower-yoke, and the like, or any combination thereof. The FPSO may also be moored to a jetty or be bottom-grounded as in the case of a gravity-based structure. In one or more embodiments, the hull can be sufficiently sized to support any suitable mooring system to adapt to any mooring system requirement on a project-to-project basis. Additionally, the FPSO can include riser systems that correspond to the mooring system used. In one or more embodiments, the hull can be configured to support any appropriate riser system matched to one or more suitable mooring systems as required on a project-to-project basis.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof is determined by the claims that follow.

We claim:

1. A floating vessel for use as an ammonia floating production storage and offloading vessel comprising:
a hull having two opposing double-side walls and a double-bottom wall;
at least two longitudinal bulkheads located within the hull, defining at least three separate storage spaces within the hull;
at least two transverse bulkheads located between the at least two longitudinal bulkheads located within the hull;
a series of cross-members, wherein the series of cross members are disposed between any of the at least two longitudinal or transverse bulkheads to provide support and stability to the bulkheads;
a deck disposed at least partially over the hull, and at least partially supported by the at least two longitudinal bulkheads, transverse bulkheads, or a combination thereof; and
at least one void located within the double-side walls or double-bottom wall of the hull, the at least one void used for ballast;
wherein the at least three separate storage spaces are configured to contain one or more liquids, pressurized gasses, or a combination thereof.

2. The floating vessel of claim 1, further comprising at least one free-standing tank located within the hull, below the deck.

3. The floating vessel of claim 1, wherein the at least two bulkheads are separated from one another by a distance less than the distance between either bulkhead and the nearest inner hull wall.

4. The floating vessel of claim 1, wherein the inner hull wall has a first and second side and the inner hull wall is supported by a plurality of transverse bulkheads that span from the first side of the inner hull wall to the second side of the inner hull wall.

5. The floating vessel of claim 1, wherein the deck is configured to support at least 50,000 tons of weight.

6. The floating vessel of claim 1, wherein the liquid is ammonia, liquified petroleum gas, or natural gas liquids and the pressurized gases are selected from the group consisting of H₂, N₂, O₂, CO₂, and water.

7. The floating vessel of claim 1, wherein the deck comprises a building configured to house or office personnel.

8. The floating vessel of claim 1, wherein the floating vessel is monitored remotely.

9. The floating vessel of claim 1, wherein the deck comprises a helideck.

10. The floating vessel of claim 1, wherein each bulkhead includes a bulkhead support affixed at or around a base of the bulkhead, the top of the bulkhead, or at both the base and top of the bulkhead to sure the bulkhead within the inner hull wall.

11. The floating vessel of claim 1, wherein the bulkheads are free-standing within the inner hull wall.

12. The floating vessel of claim 1, wherein the bulkheads are integrated insulated tanks disposed within the inner hull wall.
